(19) United States
(12) Patent Application Publication
(10) Pub. No.: US 2026/0286562 A1
(43) Pub. Date: Sep. 24, 2026

(54) DEPOSITION OF ALIGNED CARBON NANOTUBE FILMS FROM A SUSPENSON UNDER SHEAR FLOW AND AN APPLIED ELECTRIC FIELD

(71) Applicant: Wisconsin Alumni Research Foundation, Madison, WI (US)

(72) Inventors: Michael Scott Arnold, Middleton, WI (US); James Unzaga, Madison, WI (US)

(21) Appl. No.: 19/087,678

(22) Filed: Mar. 24, 2025

(51) Int. Cl. C25D 13/02; C08K 9/08; C09D 5/44; C09D 7/62; C09D 165/00; C25D 13/22

(52) U.S. Cl. CPC C25D 13/02; C09D 5/4419; C09D 7/62; C09D 165/00; C25D 13/22; C08K 9/08; C08K 2201/001; C08K 2201/011

(57) ABSTRACT

Methods for forming films of aligned carbon nanotubes, films formed by the methods, and electronic devices that incorporate the films are provided. The films are formed by flowing a suspension of organic material-coated carbon nanotubes through a channel across which an electric field is applied. The electric field creates an attractive force between the organic material-coated carbon nanotubes and the floor of the channel, which provides a deposition substrate for the carbon nanotube film. The surface of the channel's deposition substrate is coated with a coating that repels the organic material-coated carbon nanotubes. Under the influence of the attractive and repulsive forces, the carbon nanotubes from the flowing suspension are deposited on the repulsive coating on the deposition substrate to form a carbon nanotube film in which the carbon nanotubes are aligned along the flow direction.

### REFERENCE TO GOVERNMENT RIGHTS

This invention was made with government support under N00014-22-1-2843 awarded by the NAVY/ONR. The government has certain rights in the invention.

### BACKGROUND

Carbon nanotubes, including single-walled carbon nanotubes (SWCNTs), are key building blocks for nanoscale science and technology due to their interesting physical and chemical properties. SWCNTs are particularly promising for high speed and low power semiconductor electronics. A challenge, however, is the hierarchical organization of these building blocks into organized assemblies and, ultimately, useful devices. Ordered structures are necessary, as random network SWCNT thin films result in sub-optimal electronic properties, including low conductance and electron mobility. Numerous techniques for aligning SWCNTs have been explored to solve this shortcoming. These approaches can be divided into two main categories: (a) direct growth via chemical vapor deposition and arc-discharge, and (b) post synthetic assembly. In the case of direct growth, both metallic and semiconducting SWCNTs are produced. In this case, the performance of SWCNT field effect transistors (FETs) that include the SWCNTs in a channel layer is limited by the metallic SWCNTs (m-SWCNTs), thus motivating attempts to purify semiconducting SWCNT (s-SWCNT) samples with homogeneous electronic properties.

A variety of post-synthetic sorting methods have been developed to separate m- and s-SWCNTs according to their specific physical and electronic structures, which are usually implemented in aqueous or organic solutions. To take advantage of the high purity of s-SWCNTs that can be produced by these solution-based sorting approaches in semiconductor electronic devices, solution-based methods for assembling and aligning s-SWCNTs, such as evaporation-driven self-assembly, blown-bubble assembly, gas flow self-assembly, spin-coating, Langmuir-Blodgett and -Shafer methods, and contact-printing assembly have been developed. While each of these methods has its strengths, new methods are still needed to improve the fidelity of s-SWCNT assembly and alignment in carbon nanotube films to improve the fabrication of practical s-SWCNT-based electronic devices.

Another technique that has been used to deposit films of carbon nanotubes is electrophoresis. Electrophoretic deposition is a process in which charged-bearing particles in suspension migrate towards an oppositely charged electrode under the influence of an externally applied electric field where they accumulate to a form a compact deposit on the electrode surface. Electrophoresis can be carried out using an alternating current (AC) or direct current (DC). However, DC electrophoretic deposition of carbon nanotubes tends to deposit the carbon nanotubes in a random arrangement. AC electrophoretic deposition can be used to form films with better carbon nanotube alignment. However, in AC electrophoresis, the carbon nanotubes are deposited bridging a pair of electrodes and deposition is a complex function of the applied field parameters, such as frequency and waveform. Moreover, excessive particle accumulation rates during electrophoresis can limit carbon nanotube alignment because the migrating particles do not have sufficient time to rearrange before accumulating on the electrode surface.

### SUMMARY

Methods for forming films of aligned carbon nanotubes are provided.

One example of a method for forming a film of aligned carbon nanotubes includes the steps of: flowing a suspension of organic material-coated carbon nanotubes through a flow channel between an electrode and a surface of a deposition substrate, wherein the surface of the deposition substrate is coated with a repulsive coating, and further wherein the organic material-coated carbon nanotubes have a positive or negative zeta potential in the suspension; generating an electric field across the flowing suspension, wherein the electric field causes the organic material-coated carbon nanotubes in the flowing suspension to migrate toward the deposition substrate and concentrate at the repulsive coating; and discontinuing the flow of the suspension, leaving a film of the organic material-coated carbon nanotubes on the repulsive coating, wherein the organic material-coated carbon nanotubes in the film are aligned along the flow direction of the suspension.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIGS. 1A and 1B are schematic diagrams illustrating the deposition of a film of aligned carbon nanotubes.

FIGS. 2A and 2B are SEM and AFM data of aligned carbon nanotube arrays deposited using a film-forming technique as described in the Example.

FIGS. 3A and 3B are AFM images showing a high degree of carbon nanotube alignment in a film deposited using a film-forming technique as described in the Example.

FIGS. 4A and 4B are SEM data of different control experiments, as described in the Example. FIG. 4A is an SEM image after a deposition completed without the presence of an electric field (no nanotubes deposit) and FIG. 4B is an SEM image of a deposition completed with a non-repulsive organic layer attached to the silicon substrate (many nanotubes deposit but without good alignment).

FIGS. 5A and 5B summarize a zeta potential measurement taken of the PFO-BPy-coated CNT-chloroform suspension used in the Example.

### DETAILED DESCRIPTION

Methods for forming films of aligned carbon nanotubes, films formed by the methods, and electronic devices that incorporate the films are provided. The films are formed by flowing a suspension of organic material-coated carbon nanotubes through a channel across which an external electric potential is applied. The applied potential creates an attractive force between the organic material-coated carbon nanotubes and the floor of the channel, which provides a deposition substrate for the carbon nanotube film. The surface of the channel's deposition substrate is coated with a coating that repels the organic material-coated carbon nanotubes. Under the influence of the attractive and repulsive forces, the carbon nanotubes from the flowing suspension are deposited on the repulsive coating on the deposition substrate to form a carbon nanotube film in which the carbon nanotubes are aligned along the flow direction. The methods provide a rapid and highly scalable means of forming a film of aligned carbon nanotubes over a large surface area. The carbon nanotube alignment and packing densities in the deposited films render the films suitable for use in a variety of high-performance electronic applications, including as channel layers in field-effect transistors (FETs).

Without intending to be bound to a particular theory behind the carbon nanotube film deposition process, the high degree of carbon nanotube alignment and packing density in the films may be attributed to the repulsion between the organic material-coated carbon nanotubes and the repulsive coating on the channel's deposition substrate. This repulsion prevents the organic material-coated carbon nanotubes from immediately adsorbing on to the deposition substrate, thereby slowing the deposition process and allowing the carbon nanotubes more time to align and densely pack prior to full film formation.

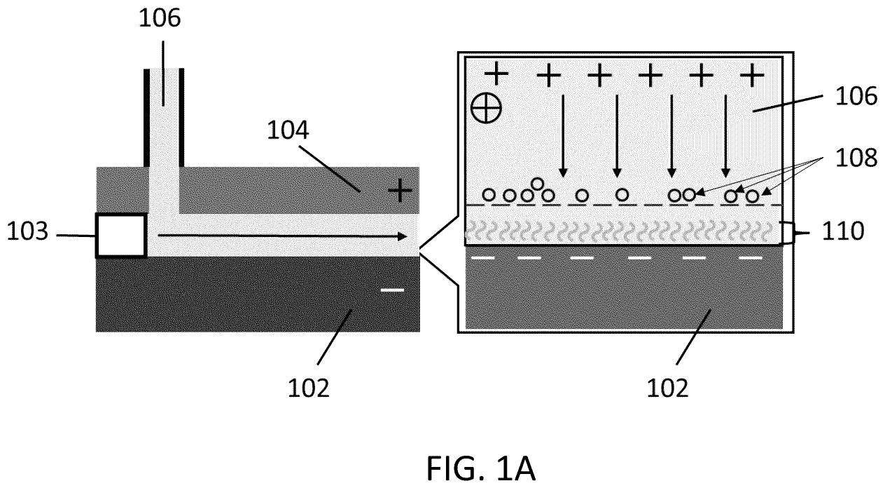

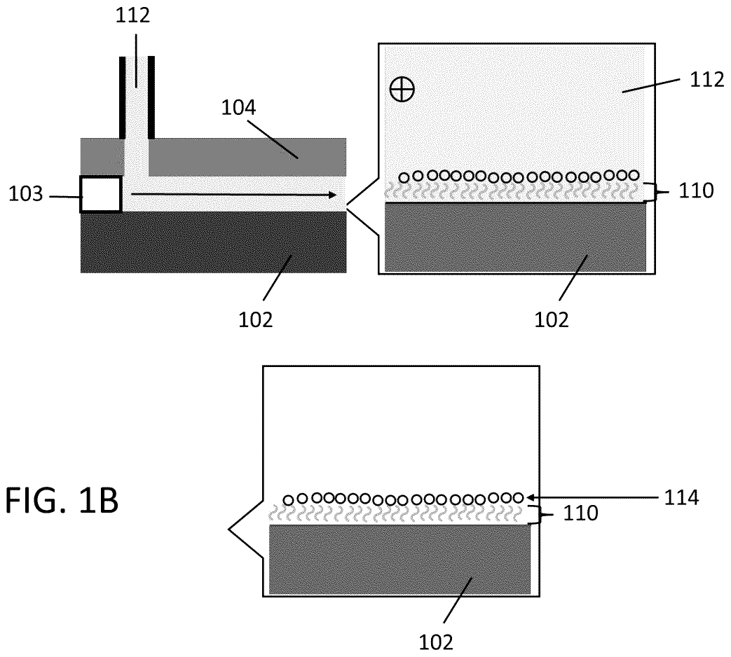

A cross-sectional view of a flow channel for forming a carbon nanotube film is illustrated schematically in FIGS. 1A and 1B. The left panels in FIGS. 1A and 1B provide a cross-sectional view along the length of the flow channel. The right panels in FIGS. 1A and 1B provide a cross-sectional view through the flow channel. The flow channel is formed between a deposition substrate 102, a top electrode 104, and channel side walls 103. The upper surface of the deposition substrate 102 has a coating 110 that repels organic material-coated carbon nanotubes 108. (In the figures, the carbon nanotubes are viewed end-on and are, therefore, represented by circles.) A fluid suspension 106 comprising carbon nanotubes 108 dispersed in a solvent flows through the channel along a flow direction (indicated by an arrow in the left panels and a circled cross in the right panels).

As fluid suspension 106 flows across coating 110, an electric field is created across the suspension, for example by applying a voltage. The electric field has field lines running perpendicular to the flow direction. The electric field can be generated by a voltage source connected between top electrode 104 and deposition substrate 102, provided deposition substrate 102 is electrically conductive. Alternatively, as discussed in more detail below, deposition substrate 102 can be disposed on a lower electrode. The electric field creates an attractive force between the carbon nanotubes in the suspension and deposition substrate 102. In the embodiment of the method shown in FIG. 1A, top electrode 104 is a positive electrode and deposition substrate 102 is electrically conducting, such that it acts as a negative electrode. However, in other embodiments, top electrode 104 is a negative electrode and deposition substrate 102 acts a positive electrode. As suspension 106 flows through the channel, carbon nanotubes 108 become aligned along the flow direction and, under the influence of the electric field, migrate toward and become concentrated at the interface of fluid suspension 106 and coating 110. The flow of the suspension is then stopped leaving a film of aligned organic material-coated carbon nanotubes on coating 110.

Notably, the direction of the electric field used in the carbon nanotube film forming methods and systems described herein is not the same as the suspension flow direction. Therefore, the methods and systems described herein are readily distinguishable from prior electrophoresis and dielectrophoresis methods that have been used to deposit carbon nanotube films.

Optionally, a rinsing fluid 112 can be flowed through the flow channel after the fluid suspension. For example, a rinsing fluid may be flowed through the flow channel to provide the organic material-coated carbon nanotubes more time to settle onto coating 110 and/or to become better aligned along the channel's flow direction. For this purpose, the rinsing fluid may comprise or consist of the solvent used in the fluid suspension, but without the organic material-coated carbon nanotubes. However, other rinsing fluids can be used. This rinse step can take place in the presence of the electric field so that the organic material-coated carbon nanotubes are immobilized on the coating.

In some embodiments, rinsing fluid 112 is a new solvent in which organic material-coated carbon nanotubes 110 are insoluble to complete the transfer and sticking of the aligned organic material-coated carbon nanotubes 108 to the organic coating 110 (FIG. 1B, top left and right panels). The flow of rinsing fluid 112 is then discontinued, leaving a film 114 of aligned organic material-coated carbon nanotubes 108 on coating 110 (FIG. 1B, bottom panel).

The carbon nanotubes that can be used to make the films include SWCNTs, including SWCNTs processed from high pressure carbon monoxide (HiPco) produced powders and SWCNTs made via arc-discharge methods. However, other types of carbon nanotubes, such as multi-walled carbon nanotubes, can also be used. Carbon nanotubes are characterized by very small diameters; for example, less than 5 nm and more typically less than 2 nm. Carbon nanotubes of various lengths can be deposited using the methods. This includes very short carbon nanotubes that have lengths of no greater than 20 nm, or even no greater than 10 nm. However, longer carbon nanotubes, including carbon nanotubes having lengths of 1 μm or longer, or 10 μm or longer (e.g., carbon nanotubes with lengths in the range from 100 nm to 1 μm), can be used. In a sample (e.g., powder) of carbon nanotubes in which the dimensions of the individual carbon nanotubes vary, the dimensions recited above refer to the average dimensions for the carbon nanotubes in the sample. However, the samples can be selected such that none of the carbon nanotubes in the sample exceed the maximum dimensions recited above. For some device applications, it is desirable for the carbon nanotubes to be semiconducting SWCNTs (s-SWCNTs). Therefore, the carbon nanotubes used in the methods can be pre-sorted to remove all, or substantially all (e.g., >90%) of the metallic SWCNTs (m-SWCNTs).

The individual carbon nanotubes are coated with an organic material. The organic material may be an organic material that was used in a pre-sorting step to separate s-SWCNTs from m-SWCNTs in a solution containing both and/or an organic material that prevents carbon nanotube aggregation and promotes the dispersion of the carbon nanotubes in the fluid suspension. For clarification, these organic material-coated carbon nanotubes each have a partial or complete coating of an organic material on their surface; they are not distributed in a continuous organic (e.g., polymer) matrix. The organic material coatings may be, but need not be, covalently bonded to the surfaces of the carbon nanotubes. Organic materials that can form the coatings include organic functional groups, monomers, oligomers, polymers, or combinations thereof. The organic functional groups, monomers, oligomers, polymers may be, but need not be, aromatic functional groups, monomers, oligomers, or polymers. The organic materials may be charged, including positively charged or negatively charged, or may be uncharged (neutral) materials.

Organic materials used in a pre-sorting step to isolate s-SWCNTs from a mixture of s-SWCNTs and m-SWCNTs are referred to herein as semiconductor-selective coatings. Semiconductor-selective coatings are known, including semiconductor-selective polymer coatings. Descriptions of such polymers can be found, for example, in Nish, A.; Hwang, J. Y.; Doig, J.; Nicholas, R. J. Highly selective dispersion of single-walled carbon nanotubes using aromatic polymers. Nat. Nanotechnol. 2007, 2, 640-6. The semiconductor-selective polymers are typically organic polymers with a high degree of π-conjugation, such as aromatic polymers, and include polyfluorene polymers, such as poly(9,9-dialkyl-fluorene) derivatives, and poly(phenyl vinylene) polymers. One specific example of a semiconductor-selective polymer is poly[(9,9-dioctylfluorenyl-2,7-diyl)-alt-co-(6,6′-[2,2′-{bipyridine}])] (PFO-BPy).

While the semiconductor-selective coatings may be conductive or semiconductive materials, they can also be electrically insulating. Optionally, the coatings can be removed from the carbon nanotubes after the carbon nanotube films have been deposited in the flow channel. For example, the coatings can be selectively dissolved or etched away. Alternatively, for polymers having a bi-pyridine repeat unit, the coatings can be removed via exposure to a transition metal salt, such as a transition metal (e.g., rhenium) carbonyl salt, as described in U.S. Pat. No. 9,327,979.

The organic material-coated carbon nanotubes are dispersed in solution to provide a fluid suspension of the carbon nanotubes. A wide variety of organic solvents and mixtures of organic solvents can be used to form the suspension, provided that the carbon nanotubes can be dispersed as single carbon nanotubes in the solvent and that the organic material-coated carbon nanotubes have a non-zero zeta potential in the suspension. The zeta potential is a measure of the effective electric charge on the surfaces of the organic material-coated carbon nanotubes due to the development of an electrical potential at the organic material-coated carbon nanotube/solvent interface in the suspension. Alternatively, the carbon nanotube suspension can be created by a charged polymer/surfactant/organic molecule that also provides charge.

The surface charges create an electrostatic attraction between the organic material-coated carbon nanotubes and the oppositely-charged electrically conductive substrate. The zeta potential for the suspended organic material-coated carbon nanotubes can be positive or negative. The sign of the surface charge will determine whether deposition takes place on a cathodic channel deposition substrate (positive surface charge) or an anodic channel deposition substrate (negative surface charge).

The surface charges may result from the adsorption of charged dopants in the solvent, which may be present as impurities or may be added to the suspension for the purpose of imparting surface charges to the organic material-doped carbon nanotubes. Examples of dopants include tetracyanoquinodimethane (TCNQ) and 2,3,5,6-tetrafluoro-7,7,8,8-tetracyanoquinodimethane (F4TCNQ). Other dopants include salts, such as metal salts, that provide ions in the suspension that adsorb to the surface of the organic material-coated carbon nanotubes to impart a positive or negative surface charge. Such salts include, for example, AuCl₃. The dopants preferably do not react irreversibly with the carbon nanotubes or, if they do, the reactions do not significantly negatively affect the electrical properties of the carbon nanotubes. The adsorbed dopants can withdraw or provide electrons to the carbon nanotubes to impart the positive or negative surface charges. The amount of doping that occurs can be quantified by measuring the bleaching of the optical absorption at the optical bandgap.

The solvents used in the fluid suspension are not particularly limited, provided that the organic material-coated carbon nanotubes are sufficiently soluble in the solvent to form a suspension. The solvent may be a non-aqueous solvent or an aqueous solvent (e.g., water). The solvents desirably have a low polarizability and include non-polar organic solvents. Examples of solvents that can be used to form the suspensions include, but are not limited to, toluene, chloroform, and 1,2-dichlorobenzene. Other solvents include carbon tetrachloride, cyclohexane, 1,2-dichloroethane, 1,1,2-trichloroethane, dichloromethane, chlorobenzene, 3-chlorotoluene, o-xylene, m-xylene, and p-xylene. (As used herein, the term solvent is used broadly to refer to a single solvent or a solvent mixture.)

The film deposition methods are carried out by creating a shear flow of the fluid suspension comprising the organic material-coated carbon nanotubes through a flow channel, whereby a flow velocity gradient is formed across the flowing suspension and the long axes of the organic material-coated carbon nanotubes become aligned in the direction of the flow. The floor of the flow channel has a repulsive coating that repels the organic material-coated carbon nanotubes. For the purposes of this disclosure, a coating is considered repulsive if the organic material-coated carbon nanotubes from a suspension more readily adsorb to the surface of the uncoated deposition substrate than they do to the surface of the repulsive coating on said substrate using the same flow conditions and applied electric field. The repulsive coating may be an organic coating or an inorganic (e.g., metal oxide) coating. By way of illustration, a surface coating comprising a self-assembled monolayer (SAM) of octadecyltrichlorosilane (OTS) on a silicon substrate provides a repulsive organic coating for PFO-BPy-wrapped s-SWCNTs because the PFO-BPy-wrapped s-SWCNTs deposit from suspension onto the OTS-coated silicon substrate at a lower number density than they do on the bare silicon substrate under the same conditions. (See, Dwyer, Jonathan H., et al. “Solvent-Mediated Affinity of Polymer-Wrapped Single-Walled Carbon Nanotubes for Chemically Modified Surfaces.” Langmuir 35.38 (2019): 12492-12500.)

The repulsive coatings are preferably sufficiently repulsive that no, or very few (e.g, linear density of fewer than ten per μm), organic material-coated carbon nanotubes deposit from the flowing suspension onto the coatings in the absence of the applied electric field.

The repulsive nature of the coating may arise from a variety of forces and interactions between the coating and the organic material-coated carbon nanotubes, such as electrostatic repulsion, steric repulsion, solvent molecule ordering, hydrophilic-hydrophobic interactions, or a combination thereof. An electrostatic repulsion can be created between a coating on the substrate and the organic material-coated carbon nanotubes by using a coating with a surface charge that is same as the surface charges of the organic material-coated carbon nanotubes (e.g., both positive or both negative). Repulsive hydrophobic-hydrophilic interactions include interactions between hydrophobic groups at the surface of an organic coating on the deposition substrate and the surface-charged organic material-coated carbon nanotubes. There may also be repulsion due to an energetic penalty arising from the exclusion of solvent molecules in the space in between the carbon nanotubes and the coated substrate as the nanotube approaches the surface. Repulsive forces of this type are described in the context of PFO-BPy-coated carbon nanotubes and an OTS-grafted surface in Langmuir 35.38 (2019): 12492-12500.

The repulsive coating on the surface of the deposition substrate can be covalently bonded to the substrate or fixed to the substrate via non-covalent interactions, such as electrostatic attraction and/or van der Waals forces. The repulsive coating comprises a material that is different from the organic material of the coating on the carbon nanotubes. Repulsive organic coatings can comprise organic functional groups on the substrate, monomers, oligomers, polymers, or a combination thereof. In some embodiments of the methods, the repulsive organic coating is a SAM on the substrate surface. SAMs are composed of a monolayer of organic molecules, each molecule having a head group that binds to the surface of the substrate and a tail group covalently bonded to the head group. The tail groups may be hydrophobic or hydrophilic. In some embodiments of the SAMs the head group comprises a silane group and/or the tail group comprises or consists of an alkyl chain. Alkyl silanes having tail groups that comprise or consist of C₁₀ to C₅₀ carbon chains are non-limiting examples of organic molecules that can be used to form SAMs on a substrate, such as a silicon substrate. However, inorganic coatings can also be used, provided they are repulsive toward the organic material-coated carbon nanotubes. By way of illustration, a coating comprising or consisting of MoOₓ where x is 2 or 3 can serve as a repulsive coating for PFO-BPY-coating carbon nanotubes do not stick.

If the deposition substrate of the flow channel is sufficiently electrically conductive it can act as an electrode and a voltage source connected across the deposition substrate and the top electrode can generate an electric field between the deposition substrate and the top electrode. In some embodiments, the deposition substrate comprises an electrically conductive layer with a thinner layer of dielectric material at its surface. For example, a thin film of dielectric material, such as silicon dioxide or silicon nitride may be applied to an underlying layer of electrically conductive material provided the film is sufficiently thin not to interfere with the deposition process. Alternatively, a thin deposition substrate that is not electrically conductive or that is poorly electrically conductive can be disposed on an electrically conductive electrode and the voltage source can be connected across the two electrodes. This design flexibility enables the deposition substrate to be composed of wide range of materials, including electrically conductive materials, semiconducting materials, and dielectric materials.

Examples of deposition substrate materials include, but are not limited to, silicon and other semiconductors and electrically conducting and semiconducting metal oxides and metal nitrides and non-metal oxides and nitrides, metals, and metal alloys. Examples of dielectric materials that can form a top layer of a deposition substrate or that can be disposed as a thin film on a bottom electrode include glasses, ceramics and plastics (e.g., polymers).

In some embodiments, the top surface of the deposition substrate to which the repulsive coating is applied is oxidized or surface treated to form surface hydroxyl groups to promote the binding of a repulsive organic coating

The top electrode and side walls of the flow channel are desirably constructed from materials to which the organic material-coated carbon nanotubes do not readily adhere to minimize the loss of nanotubes to these surfaces. Additionally, the side walls of the flow channel should be composed of an electrically insulating material to prevent the electrodes from short circuiting.

The applied bias, concentration of carbon nanotubes in the suspension, and flow rate can be selected to produce a carbon nanotube film in which the carbon nanotubes have a desired degree of alignment and/or packing density. Generally, a larger applied bias will result in a higher density of deposited carbon nanotubes but might result in a lower degree of alignment. Therefore, the bias voltage can be selected to achieve an optimal balance between these two considerations. The optimal bias voltage will depend on a variety of factors, including the zeta potential of the organic material-coated carbon nanotubes, the solvent used in the suspension, and/or the material of the repulsive coating on the channel substrate, and the distance between the top and bottom electrodes. In some embodiments, a bias voltage in the range from 0.01 V to 100 V is used. However, voltages outside this range can also be used and the voltage will generally scale with the separation distance between the top and bottom electrodes. Illustrative separation distances include, but are not limited to, those in the range from 25 μm to 100 μm.

The concentration of the organic material-coated carbon nanotubes in the fluid suspension can be selected to provide a carbon nanotube film having a desired carbon nanotube density; typically a higher concentration of organic material-coated carbon nanotubes in the suspension will produce a film with a higher concentration of carbon nanotubes and increased alignment, at least within a given concentration window, which can be determined experimentally. A wide range of carbon nanotube concentrations can be employed. By way of illustration only, in some embodiments of the methods, the fluid suspension has an organic material-coated carbon nanotube concentration in the range from 0.01 μg/mL to 250 μg/mL, including in the range from 10 μg/mL to 150 μg/mL.

The flow properties of the suspension can be controlled by selection of flow channel dimensions and flow rate. The lengths and widths of the flow channels are not particularly limited and can be selected to provide a carbon nanotube array over a large surface area, including wafer-scale areas. By way of illustration, some embodiments of the channels have lengths of at least 1 mm, at least 10 mm, at least 100 mm, at least 1 m, or larger. Some embodiments of the channels have widths, as measured by the inner, lateral diameter of the channel, of at least 500 μm, at least 1 mm, at least 10 mm, at least 100 mm, at least 1 m, or larger. This includes channels having widths in the range from 500 μm to 500 mm, further includes channels having widths in the range from 700 μm to 30 mm, and still further includes channels having widths in the range from 1 mm to 20 mm. As a result of this flexibility in the channel dimensions, carbon nanotube films covering surface areas of 1 cm², 10 cm², 100 cm², and larger can be deposited.

Illustrative flow rates that can be used to provide shear flow in the channel include those in the range from 1 ml/min to 2000 ml/min, including those in the range from 50 ml/min to 200 ml/min. However, flow rates outside of these ranges can be used.

Once a desired concentration of carbon nanotubes has accumulated at the surface of the repulsive coating, the flow of the suspension is discontinued. Films having a high degree of carbon nanotube alignment and packing density can be formed quickly using the methods described herein. For example, the films can be formed using a flow period of 5 minutes or less, 1 minute or less, and 30 seconds or less. However, longer flow periods can also be used.

In some embodiments, after the flow of the suspension is discontinued, the organic material-coated carbon nanotubes on the repulsive coating are rinsed with a solvent in which the organic material-coated carbon nanotubes are insoluble to enhance the interaction between the coating the deposited organic material-coated carbon nanotubes. In these embodiments, the rinse solvent can be chosen based on the solubility properties of the organic material-coated carbon nanotubes, which will depend on the organic material that is used. By way of illustration only, alcohols, such as isopropanol, can be used. The organic material-coated nanotubes need not be 100% insoluble in the rinse solvent. For a rinse solvent to be considered one in which the organic material-coated carbon nanotubes are “insoluble,” it is sufficient that the organic material-coated nanotubes are less soluble in the rinse solvent than in the solvent of the suspension, such that the rinse solvent promotes the separation of the organic material-coated carbon nanotubes from solution to further the adhesion of the organic material-coated carbon nanotubes to the repulsive coating on the deposition substrate surface. Thus, the suspension solvent and the rinse solvent will have different solvent properties. For example, if the suspension solvent is a non-polar solvent the rinse solvent may be a polar solvent (or vice versa) and/or if the suspension solvent is an aprotic solvent the rinse solvent may be a protic solvent (or vice versa).

The density of the carbon nanotubes in the deposited films will depend on a variety of factors, including the channel dimensions, carbon nanotube concentration in the suspension, flow rate, and/or the duration of the deposition process. The carbon nanotubes can be deposited in a single monolayer or in multiple layers on the repulsive coating. The density of carbon nanotubes in the films refers to their linear packing density, which can be quantified in terms of the number of carbon nanotubes per μm in a layer and measured as described in Joo et al., Langmuir, 2014, 30(12), pp. 3460-3466 (“Joo et al.”). In some embodiments, the deposited arrays have a carbon nanotube density of at least 10 carbon nanotubes/μm. This includes embodiments in which the arrays have a carbon nanotube density of at least 20 carbon nanotubes/μm and at least 50 carbon nanotubes/μm. By way of illustration only, films having a density of carbon nanotubes in the range from 100 to 350 carbon nanotubes/μm in a monolayer or in each or multiple deposited layers can be formed.

For most applications, it is not necessary that all the deposited carbon nanotubes be aligned; it is sufficient that the average degree of alignment of the carbon nanotubes in the film is measurably greater than that of a film of randomly oriented carbon nanotubes. The degree of alignment of the carbon nanotubes in the films refers to their degree of alignment along their longitudinal axes (lengths) within the film, which can be quantified using polarized Raman spectroscopy, as described in Joo et al. (2014). In some embodiments, the deposited films have a carbon nanotube mean degree of alignment of ±40° or better. (That is, the mean of the magnitude of misalignment for the carbon nanotubes in the film is no greater than 40°.) This includes embodiments in which the carbon nanotubes have a mean degree of alignment of ±20° or better, further includes embodiments in which the carbon nanotubes have a mean degree of alignment of ±4° or better, and still further includes embodiments in which the carbon nanotubes have a mean degree of alignment of ±1° or better. For some electronic device applications, such as channel layers in thin film transistors, imperfect alignment may be preferred to ensure continuous interconnectivity of the carbon nanotubes over a surface area having dimensions greater than the lengths of the carbon nanotubes.

### Example

This example illustrates methods of depositing films of aligning organic material-coated carbon nanotubes from a suspension undergoing shear flow in a flow channel under an applied bias.

### Materials and Methods

Forming a self-assembled monolayer on a silicon wafer with thermally grown oxide using octadecyltrichlorosilane: Si wafers with 150 nm thermally grown oxide were purchased from Addison Semiconductor Materials Inc. As received, they were first piranha treated in 30 ml of H₂SO₄ mixed with 15 ml H₂O₂ for 1 hour at 110° C. A procedure adapted from Dwyer, Jonathan H., et al. “Solvent-Mediated Affinity of Polymer-Wrapped Single-Walled Carbon Nanotubes for Chemically Modified Surfaces.” Langmuir 35.38 (2019): 12492-12500 was used. Specifically, OTS (Sigma Aldrich) was dissolved in toluene solvent at a concentration of 5 mM. A 6 cm² wafer was immersed in 20 ml of the OTS/toluene solvent solution for 24 hours and then sonicated in chloroform for 5 minutes. To confirm the presence of the OTS, the contact angle was measured on the substrate at 5 different points with an average of 110 degrees. This is consistent with previous findings in the scientific literature of the contact angle for dense OTS films.

Forming organic material-coated carbon nanotube suspensions: Polymer-coated carbon nanotube suspensions were initially extracted from a mixture of arc-discharge SWCNT powders (2 mg mL⁻¹) and PFO-BPy (American Dye Source, Inc., Quebec, Canada; #AD153-UV, 2 mg mL⁻¹). This mixture was sonicated with a horn tip sonicator (Fisher Scientific, Waltham, MA; Sonic dismembrator 500) for 30 min in toluene (60 mL). The solution was centrifuged in a swing bucket rotor at 300000 g for 10 min to remove undispersed material. The supernatant was then centrifuged and dispersed with sonication via the horn tip sonicator three times in toluene to rinse off as much excess PFO-BPy as possible. The final solution was prepared by horn-tip sonication of the rinsed SWCNT pellet in chloroform. The final concentrations of nanotubes in chloroform included 20 to 250 μg/mL, also including 20-150 μg/mL.

The wafer was placed between two conductive metallic plates (an upper plate and a lower plate) with a 50 μm-thick polyfluoroalkyl spacer between the silicon (oxide side) and one of the plates. The spacer defines the gap between the upper surface of the Si wafer and the upper plate and provides channel sidewalls, while the OTS-coated silicon wafer provides the deposition substrate of the channel. The upper plate has an inlet hole allowing fluids to pass into the channel. The inlet leads to syringe pumps where the solvents and suspension of polymer-coated semiconducting carbon nanotubes (also referred to as a carbon nanotube “ink”) (60 μg/ml) are injected. The line was loaded with an organic solvent (e.g., chloroform or toluene) and the carbon nanotube ink was injected into the line. No air bubbles were present. A bias (0 to 20V) was applied across the two metallic plates. The syringe pump was set to inject at a given ramp rate, flow rate (1 ml/min to 1000 ml/min) and volume (20 ml). Isopropanol (10 ml) was then injected (1 to 30 ml/min) into the line to rinse the silicon wafer and fix the carbon nanotube film to the OTS SAM. The bias across the plates was removed and the wafer was dried.

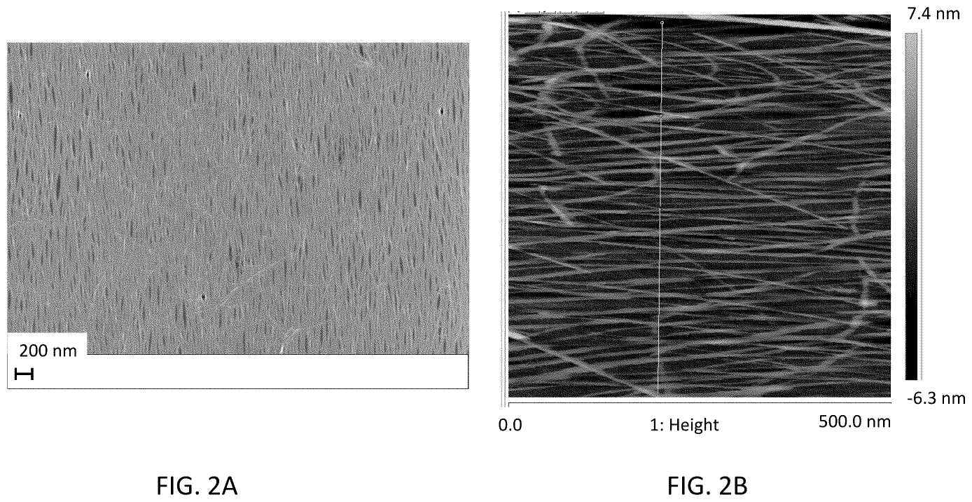

FIG. 2A shows SEM and AFM images of a film of aligned carbon nanotubes deposited using a film-forming technique as follows. A dry oxide silicon wafer was surface functionalized with OTS using the procedure above. All subsequent substrates were functionalized with the same procedure unless stated otherwise. The film was formed by injecting 1 milliliter of 100 μg/ml the PFO-BPy-coated carbon nanotube suspension at a rate of 100 ml/min using a syringe pump into a flow channel, as shown in FIG. 1A, with the potential set to 20V. (All trials used 50 μm PFA spacer.) After injection of the fluid suspension, the PFO-BPy-coated carbon nanotube film was rinsed with 20 ml of ethanol-stabilized chloroform at a rate of 100 ml/min and then 10 ml isopropanol injected manually. After being blown dry, the resulting film was characterized with cross-polarized optical microscopy and SEM. FIG. 2A shows a film of highly aligned array of carbon nanotubes aligned along the direction of flow.

FIG. 2B shows SEM and AFM images of a film of PFO-BPy-coated carbon nanotubes deposited using 0.5 ml of a fluid suspension with a PFO-BPy-coated carbon nanotubes concentration of 60 μg/ml at 40V, the fluid suspension flow rate was 100 ml/min. After the flow of the fluid suspension was complete, the film was rinsed with 20 ml of ethanol-stabilized chloroform at a flow rate of 100 ml/min and then 10 ml of isopropanol injected manually. After being blown dry, the resulting film was characterized with SEM and AFM. FIG. 2B shows the alignment of the carbon nanotubes in the along the direction of flow (left to right on the image).

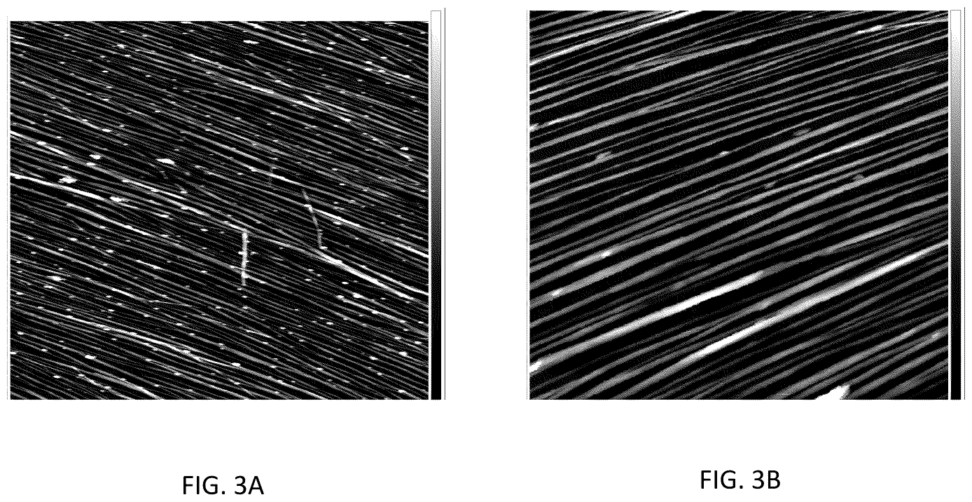

FIGS. 3A and 3B are AFM images showing a high degree of carbon nanotube alignment in a film deposited as follows. The film (1 μm by 1 μm, FIG. 3A; and 500 nm by 500 nm, FIG. 3B) was deposited using 1 ml of a fluid suspension of PFO-BPy-coated carbon nanotubes with a concentration of 60 μg/ml at a flow rate of 100 ml/min with 20V of bias. After the flow of fluid suspension ceased, the film was rinsed with 20 ml of ethanol-stabilized chloroform at a flow rate of 100 ml/min and then 10 ml of isopropanol injected manually. After being blown dry, the resulting film was characterized using high-resolution AFM. FIGS. 3A and 3B demonstrate the high degree of alignment that can be achieved using the techniques described herein.

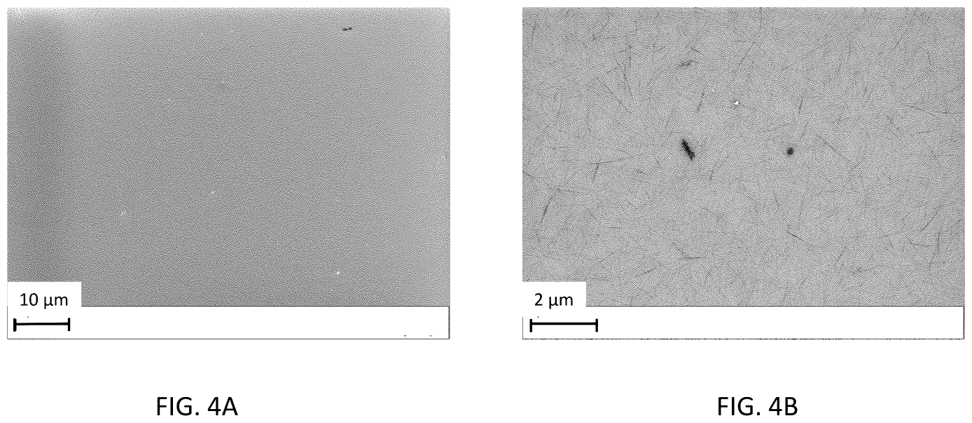

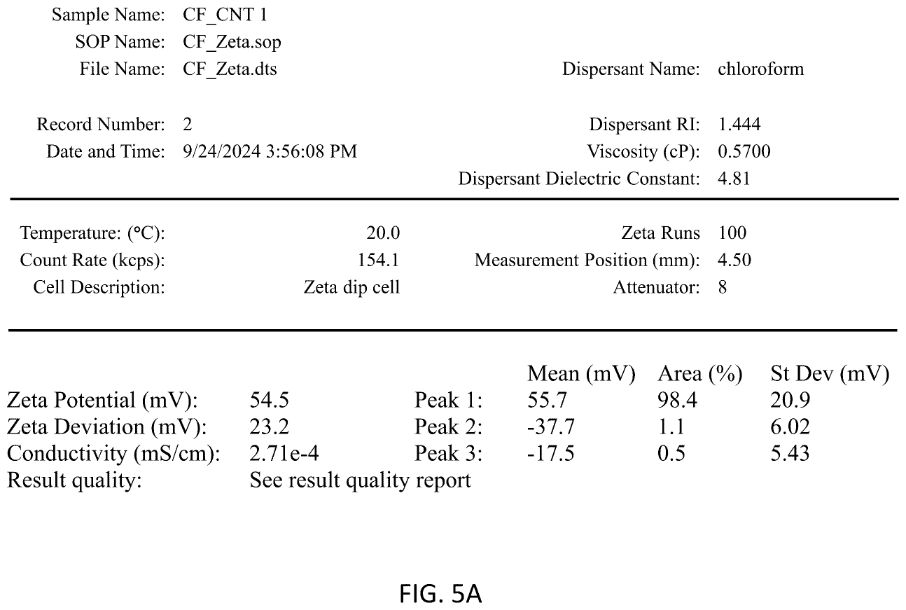

FIGS. 4A and 4B are SEM images of different control experiments, FIG. 4A is an SEM image after a deposition completed in the absence of an electric field (no nanotubes deposit) and FIG. 4B is an SEM image of a deposition completed with a non-repulsive organic layer attached to the silicon substrate (many nanotubes deposit but without good alignment). The film shown in FIG. 4A was deposited using 1 ml of a fluid suspension of PFO-BPy-coated carbon nanotubes with a concentration of 60 μg/ml at a flow rate of 100 ml/min. No bias was applied. After the flow of suspension was ceased, the film was rinsed with 20 ml of ethanol-stabilized chloroform at a flow rate of 100 ml/min and then 10 ml of isopropanol manually injected. After being blown dry, the resulting film was characterized using SEM. The OTS completely repelled all CNTs. Thus, FIG. 4A demonstrates the need for an electric field during the deposition of the coated carbon nanotubes.

The film shown in FIG. 4B was deposited onto a hexamethyldisilazane (HMDS) functionalized substrate. The substrate was piranha treated using the same procedure used for OTS and then functionalized using HMDS vapor for 3 hours (instead of OTS). 1 ml of a fluid suspension of PFO-BPy-coated carbon nanotubes with a concentration of 60 μg/ml at a flow rate of 100 ml/min was injected into the flow channel. No bias was applied across the substrate. The film was rinsed with 20 ml of ethanol-stabilized chloroform at a flow rate of 100 ml/min and then 10 ml of isopropanol manually injected. After being blown dry, the resulting film was characterized using SEM. FIG. 4B demonstrates the need for a repulsive layer on the substrate for improved carbon nanotube alignment. Without the electric field and without the OTS, the degree of alignment was not good.

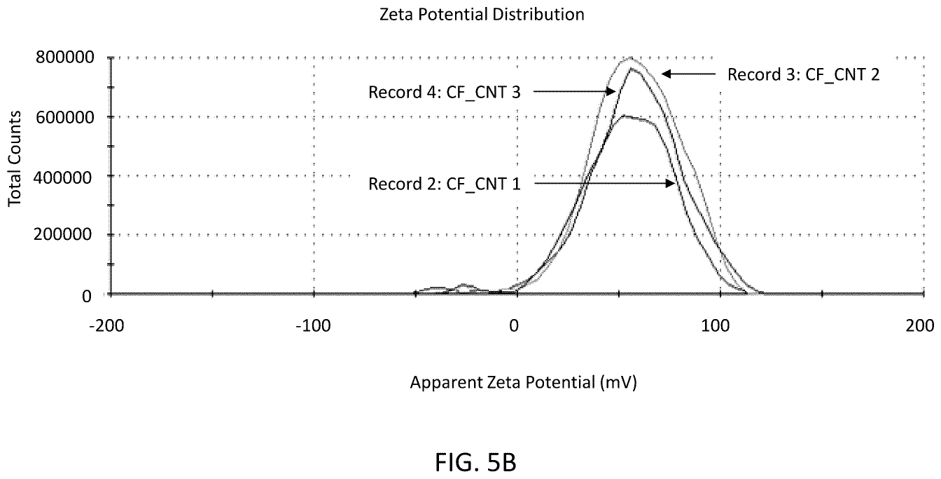

FIGS. 5A and 5B provide a summary of a zeta potential measurement parameters (FIG. 5A) and graph (FIG. 5B) taken of the PFO-BPy-coated CNT-chloroform suspension used for the deposition of the films. This measurement was taken by injecting the fluid suspension into a dip cell cuvette used for organic solvents. The cell was inserted into a Malvern Zetasizer Nano ZSP and the values were averaged over 300 scans. The fluid suspension had a peak at 55.7 mV with a standard deviation of 20.9 mV. The exact value of the fluid suspension's zeta potential was not measured, but the sign of the zeta potential was determined and explains why the carbon nanotubes were attracted to the cathode.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

If not already included, all numeric values of parameters in the present disclosure are proceeded by the term “about” which means approximately. This encompasses those variations inherent to the measurement of the relevant parameter as understood by those of ordinary skill in the art. This also encompasses the exact value of the disclosed numeric value and values that round to the disclosed numeric value.

What is claimed is:

1. A method of forming a film of aligned carbon nanotubes, the method comprising:
flowing a suspension of organic material-coated carbon nanotubes through a flow channel between an electrode and a surface of a deposition substrate, wherein the surface of the deposition substrate is coated with a repulsive coating, and further wherein the organic material-coated carbon nanotubes have a positive or negative zeta potential in the suspension;
generating an electric field across the flowing suspension, wherein the electric field causes the organic material-coated carbon nanotubes in the flowing suspension to migrate toward the deposition substrate and concentrate at the repulsive coating; and
discontinuing the flow of the suspension, leaving a film of the organic material-coated carbon nanotubes on the repulsive coating, wherein the organic material-coated carbon nanotubes in the film are aligned along the flow direction of the suspension.

2. The method of claim 1, wherein the organic material of the organic material-coated semiconducting single-walled carbon nanotubes comprises an aromatic polymer.

3. The method of claim 1, wherein the organic material-coated carbon nanotubes comprise organic material-coated semiconducting single-walled carbon nanotubes.

4. The method of claim 3, wherein the organic material of the organic material-coated semiconducting single-walled carbon nanotubes comprises a polyfluorene polymer or a poly(phenyl vinylene) polymer.

5. The method of claim 1, wherein the deposition substrate comprises a layer of doped silicon with an overlying layer of silicon dioxide.

6. The method of claim 1, wherein there is an electrostatic repulsion between the organic material-coated carbon nanotubes and the repulsive coating.

7. The method of claim 1, wherein the organic material-coated carbon nanotubes have a positive zeta potential in the solution.

8. The method of claim 1, wherein the organic material-coated carbon nanotubes have a negative zeta potential in the solution.

9. The method of claim 1, wherein the repulsive coating is an organic coating.

10. The method of claim 9, wherein the organic coating is a self-assembled monolayer.

11. The method of claim 10, wherein the self-assembled monolayer comprises organic molecules having tail groups comprising alkyl chains with an alkyl chain length of at least ten carbon atoms.

12. The method of claim 11, wherein the organic molecules are alkyl silane molecules.

13. The method of claim 12, wherein the organic material-coated carbon nanotubes have a positive zeta potential in the solution.

14. The method of claim 10, wherein the organic material of the organic material-coated semiconducting single-walled carbon nanotubes comprises an aromatic polymer.

15. The method of claim 14, wherein the deposition substrate comprises a layer of doped silicon with an overlying layer of silicon dioxide.

16. The method of claim 1, wherein the repulsive coating is an inorganic coating.

17. The method of claim 1, wherein the suspension of organic material-coated carbon nanotubes is flowed through the flow channel for a time sufficient to form the film of aligned organic material-coated carbon nanotubes with a carbon nanotube packing density of at least 50 carbon nanotubes/μm.

18. The method of claim 17, wherein a flow rate of the suspension of organic material-coated carbon nanotubes and a field strength of the electric field are selected to form the film of aligned organic material-coated carbon nanotubes with a carbon nanotube degree of alignment of ±20° or better.

19. The method of claim 18, wherein the film of aligned organic material-coated carbon nanotubes is formed with a carbon nanotube packing density of at least 100 carbon nanotubes/μm and a carbon nanotube degree of alignment of ±10° or better.

20. The method of claim 1, further comprising flowing a rinse solution over the film of the organic material-coated carbon nanotubes.
